(19) United States
(12) Patent Application Publication
(10) Pub. No.: US 2008/0031173 A1
(43) Pub. Date: Feb. 7, 2008

(54) METHOD AND APPARATUS FOR TRANSMITTING TRAFFIC INDICATION MESSAGE IN SLEEP MODE

(76) Inventors: Yan ZHANG, Shenzhen (CN); Yongmao LI, Shenzhen (CN)

Correspondence Address: LADAS & PARRY LLP, 224 SOUTH MICHIGAN AVENUE, SUITE 1600, CHICAGO, IL, 60604, US

(21) Appl. No.: 11/755,888

(22) Filed: May 31, 2007

Related U.S. Application Data
(63) Continuation of application No. PCT/CN06/01307, filed on Jun. 13, 2006.

(30) Foreign Application Priority Data
Jun. 15, 2005 (CN) 200510075326.1

(51) Int. Cl. G08C 17/02

(52) U.S. Cl. 370/311

(57) ABSTRACT

A method and apparatus for transmitting a Traffic Indication message from a BS to a MSS in Sleep Mode is provided in embodiments of the present invention. The method includes: transmitting, by the BS, a Traffic Indication message to the MSS, and setting a flag in the Traffic Indication message for indicating the indication mode of the traffic transmission of a sleep group; receiving, by the Mobile Subscriber Station, the Traffic Indication message, and determining whether each sleep group has a traffic transmission indication according to the flag, if so, the Mobile Subscriber Station changes the corresponding state of the sleep group to non-activated and receives the traffic; otherwise, the Mobile Subscriber Station maintains the sleep group in the activated state. According to an embodiment of the present invention, any indication mode of the traffic transmission can be carried flexibly, thus the problem that only one indication mode of the traffic transmission can be selected is avoided, hence overhead of the Traffic Indication message is reduced and air interface resource is saved.

The present application is a continuation of PCT application PCT/CN2006/001307, filed on Jun. 15, 2005, entitled “Method and Apparatus for Transmitting Traffic Indication Message in Sleep Mode”, which is incorporated by reference herein in its entirety.

### FIELD OF THE INVENTION

The present invention relates to a field of mobile communication, and particularly to a method and an apparatus for transmitting a Traffic Indication message from a BS (Base Station) to an MSS (Mobile Subscriber Station) in Sleep Mode.

### BACKGROUND OF THE INVENTION

In a mobile communication system, the length of standby time greatly affects the moving freedom of a subscriber terminal, and two approaches may be used for prolonging the standby time, one is using high efficient batteries; the other is reducing a meaningless power consumption of a mobile terminal as far as possible. IEEE (Institute of Electrical and Electronic Engineers) 802.16e is a standard for Mobile Broadband Wireless Access Systems being drawn, and the Sleep Mode of a mobile terminal defined in the IEEE 802.1e/D8 is the latter. The so-called Sleep Mode refers to a process during which an air interface temporarily interrupts a connection with the BS within an interval negotiated in advance by the mobile terminal and the BS. The process for implementing the Sleep Mode may reduce transmission requests of the mobile terminal on the uplink and downlink, and hence reduce the power consumption of MSS.

The MSS may actively transmit a Sleep Request message MOB_SLP_REQ to a Serving BS (Serving Base Station) to request to enter the Sleep Mode, then the Serving BS transmits a Sleep Response message MOB_SLP_RSP to approve or deny the MSS to enter the Sleep Mode. The BS may also actively transmit the MOB_SLP_RSP message to ask the MSS to enter the Sleep Mode, and on receiving this message, the MSS commonly enters the Sleep Mode according to parameters carried in the MOB_SLP_RSP message.

Now the above-mentioned protocol prescribes that the MSS negotiates with the BS to classify a current service stream into three classes of sleep groups according to QoS (Quality of Service) demand and characteristics of the stream, and uses different sleep strategies for different classes of sleep groups; each class may include many sleep groups, a same sleep strategy and different sleep parameters are used between sleep groups of the same class, and the sleep parameters are selected according to the characteristics of the traffic included in each group. Each sleep group may include many service streams, and each service stream represents a traffic connection between the MSS and the BS, which may be an uplink or a downlink and identified with a 16-bit CID) (Connection Identifier). The sleep state of each sleep group includes an activated state and a non-activated state. In the activated state, the machine in sleep state of the sleep group normally operates; in the non-activated state, the machine in sleep state of the sleep group is reset and stops operating. There are many sleep groups in the MSS, the time interval not overlapping with interception window of each sleep group is an Unavailability interval, and other time interval not overlapping with the Unavailability interval is an Availability interval. Actually, the MSS is in the sleep mode only when it is in the Unavailability interval, and meanwhile, all the sleep groups of the MSS are in a sleep window state. In the Availability interval, certain sleep groups may be in the sleep window state while other sleep groups may be in an interception state, and actually the MSS is in a wake state, and only the machines in sleep state of the different sleep groups are in the different states.

Power_Saving_Class_Type=1 is defined for the first class of sleep group which is generally used for a traffic without high real-time demand. Its sleep strategy is: a fixed length for the interception window and a variable length for the sleep window are used, the interception window alternates with the sleep window, and the length of the current sleep window is twice as long as that of the previous sleep window till it reaches the prescribed maximum, then the sleep window maintains its length and alternates with the interception window, and the machine in sleep state of the sleep group will not stop until the MSS or the BS initiates a change request of sleep state and sets the sleep state to the non-activated state.

Power_Saving_Class_Type=2 is defined for the second class of sleep group which is generally used for the traffic of periodically transmitting data. Its sleep strategy is: a fixed length for the interception window and a fixed length for the sleep window are used, and the interception window alternates with the sleep window, and the machine in sleep state of the sleep group will not stop until the MSS or the BS initiates a change request of sleep state and sets the sleep state to the non-activated state.

Power_Saving_Class_Type=3 is defined for the third class of sleep group which is generally used for the multicast traffic. Its sleep strategy is: the sleep window is arranged only once, after the sleep window times out, the sleep state of the sleep group is the non-activated state and the machine in sleep state stops, and it will not be activated until the MSS or the BS reactivates the machine in sleep state of this group through message interaction.

For the first class of sleep group, the BS may transmit a Traffic Indication message MOB_TRF_IND in the interception window of the sleep group for indicating whether traffic data for the service stream of this sleep group exists. If the Traffic Indication message received by each sleep group of the first class in the MSS in the Availability interval indicates that the traffic data for the sleep group exits, the sleep state of the sleep group is changed to the non-activated state, and the machine in sleep state is reset; otherwise, the sleep state of the sleep group is still in the activated state, the machine in sleep state operates as usual and enters the sleep state after the interception window ends; if traffic data for the service stream of the sleep group exists, the sleep state of the sleep group is changed to the non-activated state, and the machine in sleep state is reset.

FIG. 1 is a schematic diagram illustrating the sleep states of two sleep groups in one MSS, the first sleep group 110 is the first class of sleep group, the BS allocates an interception window 111 with a fixed length and a sleep window 112, the length of which is twice as long as that of the previous sleep window; and the second sleep group 120 is the second class of sleep group, the BS allocates an interception window 121 with a fixed length and a sleep window 122 with a fixed length. The oblique line area 130 shows integrated effect of the two classes of sleep groups, wherein, the oblique line area with shadow 131 represents Availability intervals, and the oblique line area without shadow 132 represents Unavailability intervals.

Now, the 802.16e/D8 draft has following prescriptions for designing the Traffic Indication message:

1. The Traffic Indication message is only arranged for the first class of sleep group.

2. The BS stops the activated state of the sleep group of the first class by transmitting the Traffic Indication message.

3. If the MSS sets a flag TRF_IND_Required in the Sleep Request message MOB_SLP_REQ, then the state of the sleep group will become the non-activated state automatically after the Availability interval ends in the case that the MSS does not receive the Traffic Indication message MOB_TRF_IND in the Availability interval.

4. For the first class of sleep group, the BS may allocate an SLPID (sleep group identifier) for each sleep group for indicating different sleep groups in each MSS (each sleep group corresponds to a unique SLPID). The BS may indicate whether each sleep group has traffic transmitted through the SLPID in the Traffic Indication message MOB_TRF_IND.

In this mode, the traffic indication is performed based on the SLPID, and the traffic indication of the related sleep groups is performed using two map tables, SLPID Group Indication bit_map and Traffic Indication bit_map.

The SLPID Group Indication bit_map is shown in FIG. 2. 1024 SLPIDs are divided into 32 traffic indication units, each traffic indication unit includes 32 SLPIDs and each traffic indication unit corresponds to 1 bit in the SLPID Group Indication bitmap.

Meanings of each bit are:

0: none of the sleep groups corresponding to SLPIDs in a traffic indication unit, which corresponds to the bit, has traffic indication;

1. at least one sleep group corresponding to an SLPID in the traffic indication unit, which corresponds to the bit, has traffic indication.

The Traffic Indication bit_map is shown in FIG. 3. The Traffic Indication bit_map includes several traffic indication units, and these traffic indication units correspond to the traffic indication units corresponding to the bits of 1 in the SLPID Group Indication bit_map in sequence. Each traffic indication unit has 32 bits, and each bit corresponds to one SLPID in the traffic indication unit, the bit of 0 represents that the sleep group corresponding to the SLPID has no traffic, and the bit of 1 represents that the sleep group corresponding to the SLPID has traffic.

5. If all the sleep groups in the MSS have traffic indications or none of them has traffic indication, a Short Basic CID (Short Basic Connection Identifier) method may be used for unifiedly indicating each sleep group of the MSS, and if a sleep group has traffic indication, the Short Basic CIDs of the MSS are listed; otherwise, the Short Basic CIDs of the MSS are not listed.

The above solutions are generally referred as Map Indication method and Short Basic Connection Identifier Indication method by those skilled in the art.

Now the format of the Traffic Indication message MOB_TRF_IND prescribed in the protocol is shown in Table 1:

TABLE 1

| Syntax | Size(bits) | Notes |
|---|---|---|
| MOB_TRF-IND_Message_Format( ){ | | |
| Management message type =52 | 8 | |
| FMT | 1 | 0: based on SLPID |
| | | indication |
| | | 1: based on CID indication |
| Reserved | 7 | Reserved bits |
| If(FMT == 0) | | |
| { | | |
| SLPID Group Indication bit-map | 32 | Each bit corresponds to one |
| | | SLPID group, and each |
| | | SLPID group includes the |
| | | SLPIDs corresponding to |
| | | the 32 sleep groups (each |
| | | sleep group corresponds to |
| | | a unique SLPID). |
| | | The meanings of each bit: |
| | | 0: none of the sleep groups |
| | | in the SLPID group has |
| | | traffic indication. |
| | | 1: at least one sleep group |
| | | in the SLPID group |
| | | corresponding to the bit has |
| | | traffic indication. |
| Traffic Indication Bitmap | variable | Traffic Indication Bitmap |
| | | of the sleep group includes |
| | | many 32-bit traffic |
| | | indication units. Each |
| | | traffic indication unit |
| | | corresponds to one SLPID |
| | | group. The traffic |
| | | indication units are |
| | | arranged in an increasing |
| | | order of the SLPID. When |
| | | at least one sleep group in |
| | | the traffic indication unit |
| | | has traffic, the traffic |
| | | indication unit is added in |
| | | the message. |
| | | 0: no traffic indication |
| | | 1: having traffic indication |
| }else{ | — | — |
| Num_pos | 7 | Number of the Short Basic |
| | | CID |
| for(i=0;i<Num_pos;i++){ | — | — |
| Short Basic CID | 12 | Short Basic Identifier of |
| | | MSS |
| } | — | — |
| } | — | — |
| While(!(byte_boundary)){ | — | — |
| Padding bits | <=7 | Padding bits |
| } | | |
| TLV_encoded items | variable | TLV encoded information |

}

The solution for transmitting the Traffic Indication message MOB_TRF_IND from the BS to the MSS in the 802.16e/D8 draft has the following disadvantages:

1. The map method is adopted when performing the sleep traffic indication with the SLPID, and in some cases, for example, if only a few sleep groups have traffic data, the map method will waste many bandwidth resources.

2. The design of the above solution is not flexible enough, and the traffic indication is performed only by the SLPID map method or the Short Basic CID method. The relationship between the two above-mentioned methods is exclusive, which increases the network burden.

### SUMMARY OF THE INVENTION

An embodiment of the present invention provides a method and an apparatus for transmitting a Traffic Indication message from a BS (Base Station) to a MSS (Mobile Subscriber Station), by which the bandwidth resources are saved, the byte overhead of the Traffic Indication message is reduced, and the solution designing is more flexible.

A method for transmitting a Traffic Indication message in the Sleep Mode according to an aspect of the present invention, wherein the MSS is in a sleep group activated state, comprising the steps of:

receiving the Traffic Indication message from a Base Station, which containing a flag for indicating the indication mode of the traffic transmission of the sleep group;

determining, by the Mobile Subscriber Station, whether each sleep group has a traffic transmission indication according to the indication mode of the traffic transmission corresponding to the flag, if it has, the MSS changes its sleep group state to a non-activated state and receives the traffic; otherwise, the MSS maintains the sleep group in the activated state.

The flag may comprise at least one bit.

The flag in the Traffic Indication message comprise several bits for respectively indicating several modes of the traffic transmission.

The indication mode of the traffic transmission comprises Map Indication, SLPID (sleep group identifier) Indication and Short Basic CID (Short Basic Connection Identifier) indication.

When the indication mode of the traffic transmission indicated by the flag is the SLPID Indication, the Traffic Indication message has a bit for setting the number of the SLPIDs.

The several bits represent the corresponding indication mode of the traffic transmission is used by setting to “1” and represent the corresponding indication mode of the traffic transmission is not used by setting to “0”.

For the several bits of the flag, the several bits setting to “1” represent that several indication modes of transmission indication are used simultaneously.

The process of the determining whether each sleep group has the traffic transmission indication comprises: when the indication mode of traffic transmission is the SLPID Indication, the MSS determines that the sleep group corresponding to the SLPID needs to receive traffic.

Another aspect of the present invention provides a method for transmitting a Traffic Indication message in Sleep Mode when the MSS is in a sleep group activated state, comprising the steps of:

transmitting, by a BS, a Traffic Indication message to a MSS, and setting a SLPID in the Traffic Indication message for identifying the sleep group in need of receiving the traffic;

after receiving the Traffic Indication message, changing, by the MSS, the corresponding sleep group state to the non-activated state, and receiving the traffic.

An apparatus for transmitting a Traffic Indication message in Sleep Mode according to still another aspect of the present invention, comprising:

a flag information setting unit, for setting a SLPID in a Traffic Indication message to identify a sleep group in need of receiving traffic; and

a transmitting unit, for transmitting the Traffic Indication message.

The apparatus may be in a BS.

A Mobile Subscriber Station according to still another aspect of the present invention, comprising:

receiving unit, adapted to receive a Traffic Indication message from a Base Station, which containing a flag for indicating the indication mode of the traffic transmission of the sleep group; and

determining unit, adapted to determine whether each sleep group has a traffic transmission indication according to the indication mode of the traffic transmission corresponding to the flag;

if it has, the Mobile Subscriber Station changes the corresponding state of the sleep group to non-activated and receives the traffic;

otherwise, the Mobile Subscriber Station maintains the sleep group in the activated state.

In the solution according to an embodiment of the present invention, the BS transmits the Traffic Indication massage for indicating the indication mode of the traffic transmission of the sleep groups when the MSS is in the Sleep Mode, and the any mode of the traffic transmission may be flexibly carried. Thus, the problem that only one indication mode of the traffic transmission can be selected is avoided, and the overhead of the Traffic Indication message is reduced and the air interface resource is saved.

### BRIEF DESCRIPTION OF THE DRAWINGS

FIG. 1 is a schematic diagram illustrating the states of the sleep group in the MSS according to the prior art;

FIG. 2 is a schematic diagram illustrating the arrangement of the SLPID Group Indication bit_map according to the prior art;

FIG. 3 is a schematic diagram illustrating the arrangement of the Traffic Indication bit_map according to the prior art;

FIG. 4 is a schematic diagram illustrating the flow of the method for transmitting the Traffic message in the Sleep Mode according to an embodiment of the present invention; and

FIG. 5 is a schematic diagram illustrating the flow for confirming the indication mode of the traffic transmission according to an embodiment of the present invention.

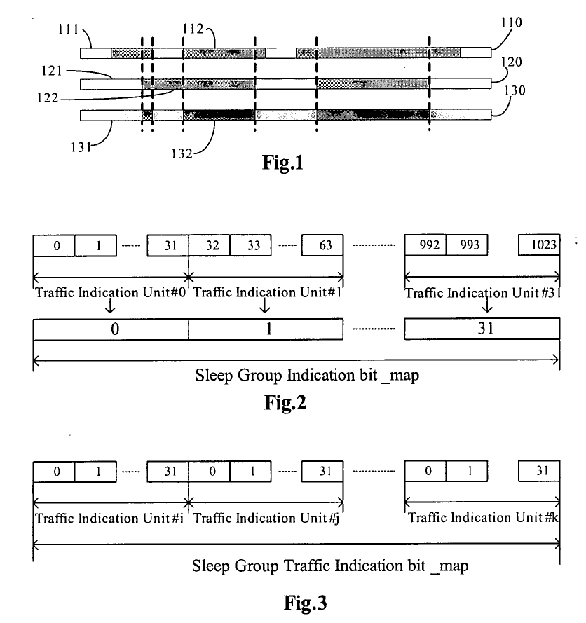

### DETAILED DESCRIPTION OF THE EMBODIMENTS

Several embodiments of the present invention will be further described with reference to the accompanying drawings hereinafter.

The solution of an embodiment of the present invention may save byte overhead of Traffic Indication message on the precondition that an MSS (Mobile Subscriber Station) is ensured to obtain corresponding traffic indication methods through the Traffic Indication message. Hence, according to embodiments of present invention, the original Traffic Indication message MOB_TRF_IND is modified, and a method of indicating with SLPID directly is added. Meanwhile, the original indication format is also modified, and the size of FMT (flag) is increased from 1 bit to 3 bits, and the former two exclusive indication solutions are modified to three indication solutions which may be selected at the same time. Each indication bit corresponds to one traffic indication method, wherein a bit setting to “1” represents that the traffic indication method corresponding to the bit is used, and a bit setting to “0” represents that the traffic indication method corresponding to the bit is not used. The format of the modified MOB_TRF_IND message is shown in Table 2.

TABLE 2

| Syntax | | Size | Notes |
|---|---|---|---|
| | MOB_TRF-IND_Message_Format( ){ | | |
| | Management message type =52 | 8 bits | |
| | FMT | 3 bit | bit0: |
| | | | map_based_format |
| | | | bit1: |
| | | | SLPID based format |
| | | | bit2: |
| | | | Short_Basic_CID |
| | | | based format |
| | reserved | 5 bits | Reserved bits |
| | If(FMT_bit0 == 1) | — | — |
| | { | — | — |
| | SLPID Group Indication bit-map | 32 | Each bit corresponds to one |
| | | | SLPID group, and each |
| | | | SLPID group includes the |
| | | | SLPIDs corresponding to |
| | | | 32 sleep groups (each sleep |
| | | | group corresponds to a |
| | | | unique SLPID). |
| | | | The meaning of each bit: |
| | | | 0: none of the sleep groups |
| | | | in the SLPID group has |
| | | | traffic indication. |
| | | | 1: at least one sleep group |
| | | | in the SLPID group |
| | | | corresponding to the bit has |
| | | | traffic indication. |
| | Traffic Indication Bitmap | variable | Traffic Indication Bitmap |

| | | of the sleep group includes |
|---|---|---|
| | | many 32-bit traffic |
| | | indication units. Each |
| | | traffic indication unit |
| | | corresponds to one SLPID |
| | | group. The traffic |
| | | indication units are |
| | | arranged in an increasing |
| | | order of the SLPID. When |
| | | at least one sleep group in |
| | | a traffic indication unit has |
| | | traffic, the traffic |
| | | indication unit is added in |
| | | the message. |
| | | 0: no traffic indication |
| | | 1: with traffic indication |
| } | | |
| If(FMT_bit1==1){ | | |
| Num_SLPID_pos | 4 bits | Number of the SLPID |
| For(i=0;i< Num_SLPID_pos;i++){ | | |
| SLPID | 10 bits | The identifier of the sleep |
| | | group |
| reserved | 2 bits | Reserved bits |
| } | | |
| } | | |
| If(FMT_bit2==1){ | | |
| Num_CID_pos | 4 bits | Number of the Short Basic |
| | | CID |
| For(i=0;i<Num_CID_pos;i++){ | | |
| Short_Basic_CID | 12 bits | Short Basic CID of the |
| | | MSS |
| } | | |
| } | | |
| While(!(byte_boundary)){ | | |
| Padding bits | <=7 bits | |
| } | | |
| TLV_encoded items | variable | — |

}

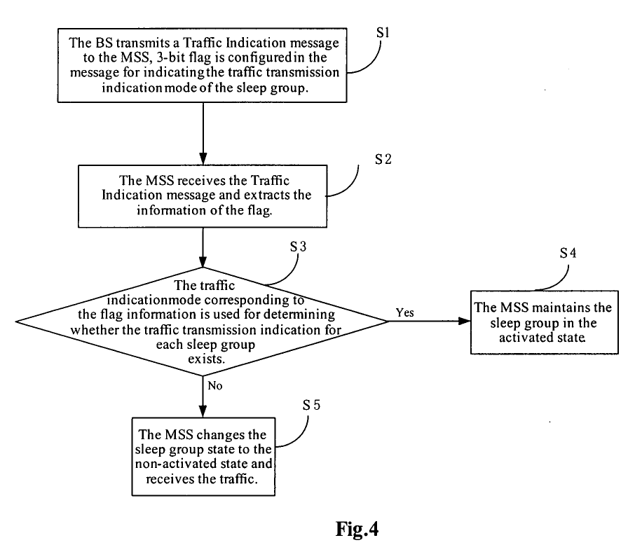

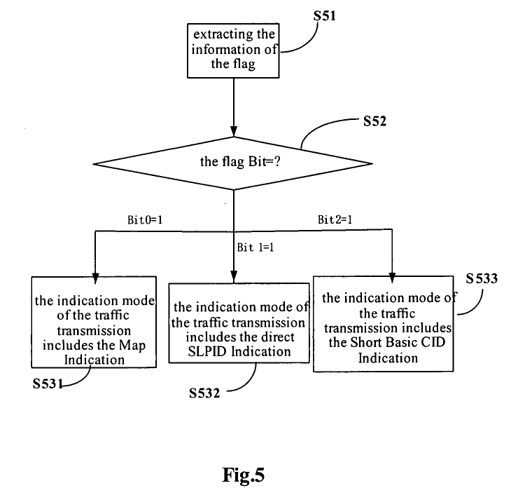

FIG. 4 is a schematic diagram illustrating the flow chart of the method for transmitting the Traffic Indication message in the Sleep Mode according to an embodiment of the present invention, and as shown in FIG. 4, an embodiment of the present invention mainly includes the steps of:

S1.A BS (Base Station) transmits a Traffic Indication message to an MSS.

The BS transmits the Traffic Indication message to the MSS, and a flag is set in the Traffic Indication message for indicating the indication mode of the traffic transmission of a sleep group; the flag occupies 3 bits, and the content indicated by the 3 bits respectively is: whether the Map Indication method is used, whether the SLPID Indication method is used and whether the Short Basic CID Indication method is used. A bit setting to “0” represents that the corresponding indication method is not used, and a bit setting to “1” represents that the corresponding indication method is used.

S2. The MSS receives the Traffic Indication message and extracts the information of the flag.

The MSS extracts the flag information from the Traffic Indication message, and the 3 bits mentioned above are used for bearing the flag information.

S3. The traffic indication method corresponding to the flag information is used for determining whether the traffic transmission indication for each sleep group exists, if so, proceeds to step S4; otherwise, proceeds to step S5.

The MSS can obtain the traffic indication methods used in the Traffic Indication message according to the settings of the 3 bits.

Herein, the 3 bits may be simultaneously set to “0” or “1” all together or partially set to “0” or “1”, which shows that the solution according to an embodiment of the present invention is more flexible than the prior art.

S4. The MSS, which is indicated as traffic is transmitted, changes the state of the sleep group to the non-activated state and receives the traffic.

According to a determination result, if the traffic indication for the sleep group exists, it shows that a transmission instruction exists, and the MSS changes the state of sleep group to non-activated and receives the traffic.

S5. The MSS maintains the sleep group in the activated state.

According to the determination result, if the traffic indication for the sleep group does not exist, it shows that no traffic transmission instruction exists, and the MSS maintains the sleep group in the activated state.

FIG. 5 is a schematic diagram illustrating the flow chart for determining the type of the traffic transmission methods according to the flag, This embodiment includes: step 51, extracting the flag; step 52, resolving the information of the flag; step 531, if the Bit0 of the flag is equal to 1, it shows that the Map Indication method is used; if the Bit1 of the flag is equal to 1, it shows that the SLPID Indication method is used; and if the Bit2 of the flag is equal to 1, it shows that the Short Basic CID Indication method is used. Though three bits are used for the flag in an embodiment of the present invention, the present invention is not limited to this and any number of bits may be used. For example, only one bit is used, if the bit of the flag is equal to 0, it shows that the SLPID Indication method is used; and if the bit of the flag is equal to 1, it shows that the Map Indication method is used.

That is to say, according an embodiment of the present invention, the setting of the flag may be carried by the following indication modes of the traffic transmission, including the Map Indication, the SLPID Indication and the Short Basic CID Indication.

According to an embodiment of the present invention, the indication mode of directly using the SLPID refers to directly indicating the sleep group in need of receiving the traffic in the message.

When the indication mode of the traffic transmission indicated by the flag is the SLPID Indication method, the number of the SLPIDs is also carried in the Traffic Indication message.

In an embodiment of the present invention, the flag is set in the Traffic indication message for indicating the mode of the traffic transmission of the sleep group, and many traffic indication methods may be carried flexibly. Thus, the problem of the prior art that only one indication mode of the traffic transmission may be selected is avoided, and the overhead of the Traffic Indication message is reduced as far as possible and the air interface resource is greatly saved.

An apparatus for transmitting Traffic Indication message in Sleep Mode according to an embodiment of the present invention, includes:

a flag information setting unit, for setting the flag information in a Traffic Indication message and indicating the indication mode of the traffic transmission of the sleep group; and the indication mode of the traffic transmission is a single mode or a combination of at least two modes; and

a transmitting unit for transmitting the Traffic Indication message.

The apparatus may be in a BS.

While the present invention has been illustrated and described with reference to some preferred embodiments, the present invention is not limited to these. Those skilled in the art should recognize that various variations and modifications can be made without departing from the spirit and scope of the present invention as defined by the accompanying claims.

1. A method for transmitting a Traffic Indication message in Sleep Mode, wherein, when a Mobile Subscriber Station in a sleep group is in an activated state, the method comprises:
receiving the Traffic Indication message from a Base Station, which containing a flag for indicating the indication mode of the traffic transmission of the sleep group;
determining, by the Mobile Subscriber Station, whether each sleep group has a traffic transmission indication according to the indication mode of the traffic transmission corresponding to the flag;
if it has, the Mobile Subscriber Station changes the corresponding state of the sleep group to non-activated and receives the traffic;
otherwise, the Mobile Subscriber Station maintains the sleep group in the activated state.

2. The method of claim 1, wherein the flag comprise at least one bit.

3. The method of claim 1, wherein, the flag in the Traffic Indication message comprise several bits for respectively indicating several modes of the traffic transmission.

4. The method of claim 1, wherein, the indication mode of the traffic transmission comprise Map Indication, Sleep Group Identifier Indication and Short Basic Connection Identifier indication.

5. The method of claim 3, wherein, the indication mode of the traffic transmission comprise Map Indication, Sleep Group Identifier Indication and Short Basic Connection Identifier indication.

6. The method of claim 4, wherein, when the indication mode of the traffic transmission indicated by the flag is the Sleep Group Identifier Indication, the number of Sleep Group Identifiers is also carried in the Traffic Indication message.

7. The method of claim 5, wherein, when the indication mode of the traffic transmission indicated by the flag is the Sleep Group Identifier Indication, the number of Sleep Group Identifiers is also carried in the Traffic Indication message.

8. The method of claim 3, wherein, the several bits represent that the indication mode of traffic transmission corresponding to the bit is used by setting to “1” and represent that the indication mode of traffic transmission corresponding to the bit is not used by setting to “0”.

9. The method of claim 3, wherein, for the bits of the flag, the bits setting to “1” represent that several indication modes of transmission indication are used simultaneously.

10. The method of claim 1, wherein, the determining whether each sleep group has the traffic transmission indication comprises: when the indication mode of traffic transmission is the Sleep Group Identifier Indication, the Mobile Subscriber Station determines that the sleep group corresponding to the Sleep Group Identifier needs to receive traffic.

11. A method for transmitting a Traffic Indication message in Sleep Mode, wherein, when the Mobile Subscriber Station in a sleep group is in an activated state, the method comprises:
transmitting, by a Base Station, the Traffic Indication message to a Mobile Subscriber Station, and setting a Sleep Group Identifier in the Traffic Indication message for indicating the sleep group in need of receiving traffic;
after receiving the Traffic Indication message, changing, by the Mobile Subscriber Station, the corresponding state of the sleep group to non-activated, and receiving the traffic.

12. An apparatus for transmitting a Traffic Indication message in Sleep Mode, wherein, the apparatus comprises:
a flag information setting unit, for setting a Sleep Group Identifier in a Traffic Indication message to indicate that a sleep group needs to receive traffic; and
a transmitting unit, for transmitting the Traffic Indication message.

13. The apparatus of claim 12, wherein, the apparatus is in a Base Station.

14. A Mobile Subscriber Station, comprising:
receiving unit, adapted to receive a Traffic Indication message from a Base Station, which containing a flag for indicating the indication mode of the traffic transmission of the sleep group;
determining unit, adapted to determine whether each sleep group has a traffic transmission indication according to the indication mode of the traffic transmission corresponding to the flag;
if it has, the Mobile Subscriber Station changes the corresponding state of the sleep group to non-activated and receives the traffic;
otherwise, the Mobile Subscriber Station maintains the sleep group in the activated state.
